(19) United States
(12) Patent Application Publication
(10) Pub. No.: US 2024/0317343 A1
(43) Pub. Date: Sep. 26, 2024

(54) HEIGHT-ADJUSTABLE SEATPOST WITH SHOCK ABSORPTION

(71) Applicant: J.D COMPONENTS CO., LTD., CHANG HUA HSIEN (TW)

(72) Inventor: NIEN-TENG KUO, CHANG HUA HSIEN (TW)

(21) Appl. No.: 18/615,431

(22) Filed: Mar. 25, 2024

(30) Foreign Application Priority Data
Mar. 25, 2023 (TW) 112202747

(51) Int. Cl. B62J 1/08

(52) U.S. Cl. CPC B62J 1/08; B62J 2001/085

(57) ABSTRACT

A height-adjustable seatpost with shock absorption includes an outer tube, an inner tube, a height adjustment mechanism, and a shock absorber. The inner tube is vertically movable disposed in the outer tube and includes a head located outside the outer tube and a bottom situated inside the outer tube. The height adjustment mechanism is located inside the inner tube and is configured to drive the inner tube to move relative to the outer tube. The height adjustment mechanism includes a stopper positioned above a stop flange on an inner wall of the inner tube and can be abutted against the stop flange. The shock absorber has two ends respectively abutted against the head of the inner tube and the stopper. The above-described design of the seatpost can prevent the saddle from being raised to an unexpected height for the rider.

### FIELD OF THE INVENTION

The present disclosure relates to a seatpost for bicycles and more particularly, to a seatpost with shock absorption that reduces the likelihood of the saddle being raised to an unexpected height for the rider.

### BACKGROUND OF THE INVENTION

Some prior bicycles equipped with height-adjustable seatposts allows riders to control the seatpost based on different road conditions (such as uphill or flat roads) to adjust the height of the saddle connected to the seatpost to an appropriate height. As a result, the riders can ride the bicycles in a more suitable position, thereby enhancing the riding comfort and safety.

As described in Taiwan Patent Application No. M523651, a shock-absorbing seatpost of bicycle includes an outer tube, an inner tube, a seatpost adjustment member, and a buffer unit located inside the inner tube. The seatpost adjustment member drives the inner tube to move vertically relative to the outer tube. The buffer unit is configured to provide a preload to the seatpost and to absorb shocks. When a rider sits on the saddle, the rider's weight applies a pressure to the buffer unit, lowering the saddle a compressed distance. When the rider wants to adjust the saddle higher, the rider must first get off the saddle and then operate the seatpost adjustment member. In such a situation, because the pressure applied to the buffer unit is released after the rider gets off the saddle, the inner tube not only moves up a distance due to the operation, but also moves up the compressed distance. As a result, there will be a difference between the rider's expected saddle height and the actual saddle height after the seatpost adjustment. That is to say, the saddle may be raised higher than the rider's expected height. Therefore, improvements to the structure of the prior bicycles are required.

### SUMMARY OF THE INVENTION

It is an objective of the present disclosure to provide a height-adjustable seatpost with shock absorption and capable of reducing the difference between the rider's expected saddle height and the actual saddle height after the seatpost adjustment, thereby reducing the likelihood of the saddle being raised to an unexpected height for the rider.

A height-adjustable seatpost with shock absorption provided in the present disclosure includes an outer tube, an inner tube, a height adjustment mechanism, and a shock absorber. The inner tube is vertically movable disposed in the outer tube and has a head located outside the outer tube and a bottom opposite the head and situated inside the outer tube. The inner tube has a stop flange located on the inner wall thereof. The height adjustment mechanism is located inside the inner tube and is configured to drive the inner tube to move relative to the outer tube. The height adjustment mechanism includes a stopper located above the stop flange and can be abutted against the stop flange. The shock absorber has two ends respectively abutted against the head of the inner tube and the stopper.

Based on the structural design of the height-adjustable seatpost, when a rider wants to adjust the height of the saddle and thus gets off the saddle, because the pressure applied to the shock absorber is released, the stop flange of the inner tube abuts against the stopper of the height adjustment mechanism. As a result, the position of the inner tube relative to the outer tube remains the same before the inner tube is driven, no matter how great the compressed distance is. Accordingly, when the rider operates the height adjustment mechanism to adjust the saddle higher, the difference between the rider's expected saddle's travel distance and the actual travel distance of the height-adjustable seatpost can be effectively reduced, thereby preventing the saddle from being raised to an unexpected height.

In one aspect, the height adjustment mechanism may be a pneumatic cylinder including a valve seat and a valve stem. The valve stem is vertically movable disposed in the valve seat and connected to the outer tube, thereby allowing the inner tube to move upwardly relative to the outer tube when the valve stem extends.

In another aspect, the valve seat and the stopper may be made separately or integrally. In the condition that the valve seat and the stopper are made separately, a screw hole may be provided at the top of the valve seat and a through hole may be provided in the stopper. The height adjustment mechanism may further include a screw passing through the through hole and screwing into the screw hole to secure the stopper to the top of the valve seat. Alternatively, the stopper can be formed by directly machining the top of the valve seat.

In another aspect, the shock absorber may be a shock-absorbing rubber, a compression spring, or even a combination of an air chamber and a floating piston. The shock absorber is not limited to the embodiments described below.

In another aspect, the shock absorber may also have a recess disposed at the bottom thereof. The screw of the height adjustment mechanism may have an integrated screw head and screw rod. After the screw is inserted into the stopper, the screw head protrudes from the top surface of the stopper and is received in the recess of the shock absorber. In this way, the shock absorber can be effectively positioned, thereby allowing the shock absorber to be compressed or extended in the correct position. Preferably, the recess of the shock absorber may also have an inner ring surface tightly connected to the screw head so as to enhance the positioning effect.

In another aspect, the inner tube may further have a cap provided with an external thread around the outer edge thereof. The head of the inner tube may have a screw hole engaged with the cap of the inner tube to enclose the shock absorber inside the inner tube.

### BRIEF DESCRIPTION OF DRAWINGS

The detailed construction, technical features, assembly, or usage of the height-adjustable seatpost with shock absorption provided by the present disclosure will be described in the detailed description of the subsequent embodiments. However, it should be understood that the detailed description, specific embodiments, and the accompanying drawings of the present disclosure, are given by way of illustration only and not by way of limitation, since various changes and modifications within the spirit and scope of the disclosure will become apparent to those skilled in the art from this detailed description.

FIG. 1 is a perspective view of a height-adjustable seatpost according to one embodiment of the present disclosure.

FIG. 2 is an exploded perspective view of the height-adjustable seatpost shown in FIG. 1.

FIG. 3 is a partial enlarged exploded perspective view of a height adjustment mechanism shown in FIG. 2.

FIG. 4 is a cross-sectional side view of the height-adjustable seatpost shown in FIG. 1, depicting the situation that the overall length of the height adjustment mechanism is minimized and the shock absorber is compressed.

FIG. 5 is a cross-sectional side view of the height-adjustable seatpost shown in FIG. 1, depicting the situation that the stop flange abuts against the stopper after the pressure applied to the shock absorber is released and the inner tube is driven by the height adjustment mechanism.

### DETAILED DESCRIPTION OF THE INVENTION

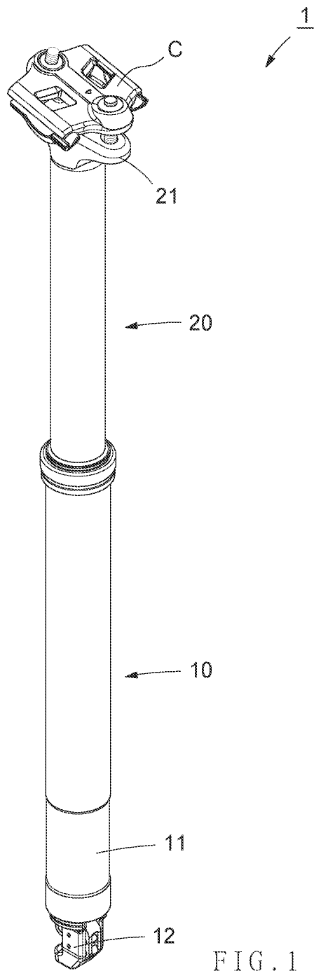

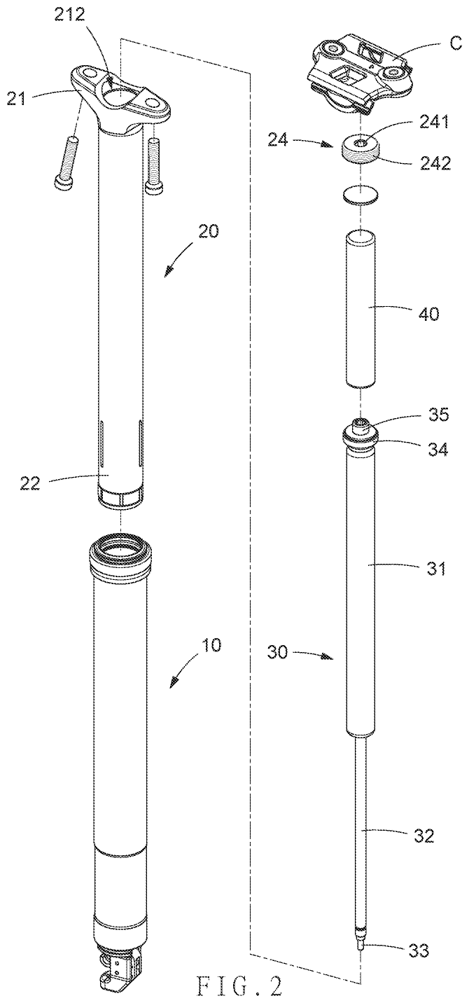

The present disclosure is described in detail with reference to the following embodiments and accompany drawings. As shown in FIGS. 1 and 2, a height-adjustment seatpost 1 with shock absorption provided in one embodiment of the present disclosure comprises an outer tube 10, an inner tube 20, a height adjustment mechanism 30, and a shock absorber 40.

The outer tube 10 is disposed inside a seat tube (not shown) of a bicycle frame, and the bottom 11 of the outer tube 10 is equipped with a linkage mechanism 12.

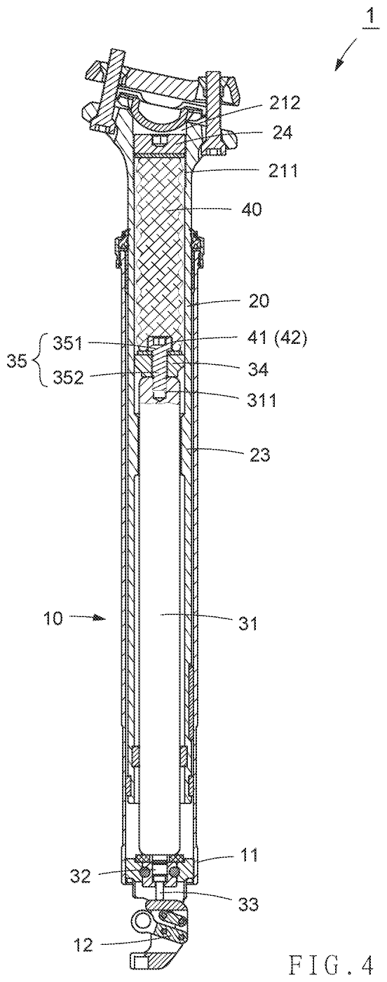

The inner tube 20 is vertically movable disposed in the outer tube 10 and has a head 21 and a bottom 22 opposite to each other. The head 21 is located outside the outer tube 10 and the bottom 22 is situated inside the outer tube 10. The head 21 is equipped with a clamping seat C for mounting a saddle (not shown). The top side of the head 21 is provided with a screw hole 211 communicating with the interior of the inner tube 20, and is provided with an opening 212 communicating with the exterior of the inner tube 20. As shown in FIG. 4, the inner tube 20 also has a stop flange 23 arranged around the inner wall of the inner tube 20. Additionally, the inner tube 20 equipped with a cap 24. The cap 24 has an end with a hexagonal hole (e.g. an Allen key hole) 241 and is provided with an external thread 242 around the outer edge thereof (see FIG. 2). The cap 24 is engaged with the screw hole 211 of the head 21 of the inner tube 20 (see FIG. 4).

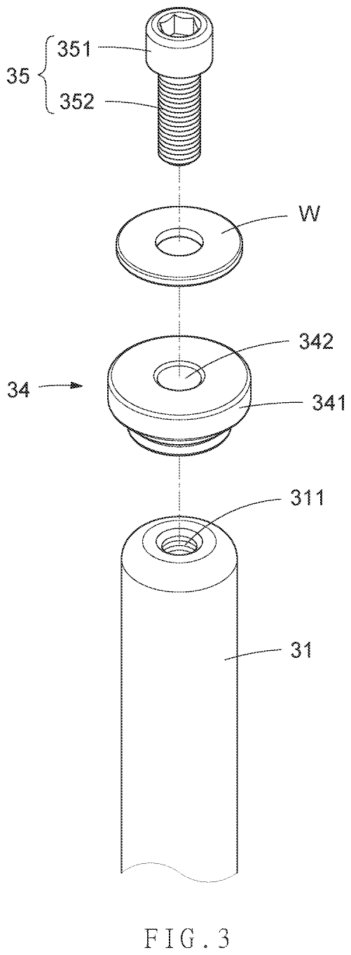

Referring to FIGS. 2 to 4, the height adjustment mechanism 30 is installed inside the inner tube 20 and drives the inner tube 20 to move relative to the outer tube 10. In this embodiment, the height adjustment mechanism 30 is installed inside the inner tube 20 through the opening 212 of the head 21 and is connected to the outer tube 10. Specifically, the height adjustment mechanism 30 is essentially a pneumatic cylinder including a valve seat 31 and a valve stem 32 vertically movable within the valve seat 31 and connected to the bottom 11 of the outer tube 10. The valve stem 32 has an end provided with a trigger lever 33. The trigger lever 33 is able to be triggered by the linkage mechanism 12 to retract or extend the valve stem 32 into or out of the valve seat 31. As shown in FIG. 3, the height adjustment mechanism 30 further includes a stopper 34 and a screw 35. The top of the valve seat 31 is provided with a screw hole 311, and the stopper 34 has an annular protrusion 341 and a through hole 342. The annular protrusion 341 has a lateral size larger than a lateral size of the valve seat 31, as shown in FIG. 4. The screw 35 has an integrated screw head 351 and a screw rod 352. The screw head 351 protrudes from the top surface of the stopper 34. The screw rod 352 passes through a washer W and the through hole 342 of the stopper 34 and is engaged with the screw hole 311 of the valve seat 31 to fix the stopper 34 to the top of the valve seat 31. The stopper 34 is located above the stop flange 23 so that the stop flange 23 is able to be abutted against the annular protrusion 341 of the stopper 34.

It is worth mentioning that in some situations, the stopper 34 may be manufactured by machining so that the stopper 34 is integrally connected to the valve seat 31.

In this embodiment, the shock absorber 40 is essentially a shock-absorbing rubber

having elasticity and being capable of elastically deforming under an external force so as to provide a buffering and shock absorbing effect. The shock absorber 40 has an upper end and a lower end respectively abutted against the cap 24 of the inner tube 20 and the stopper 34. The shock absorber 40 has a recess 41 disposed at the bottom thereof, and the recess 41 has an inner ring surface 42. The screw head 351 is received in the recess 41 and tightly connected to the inner ring surface 42 so that the shock absorber 40 can be effectively positioned above the stopper 34.

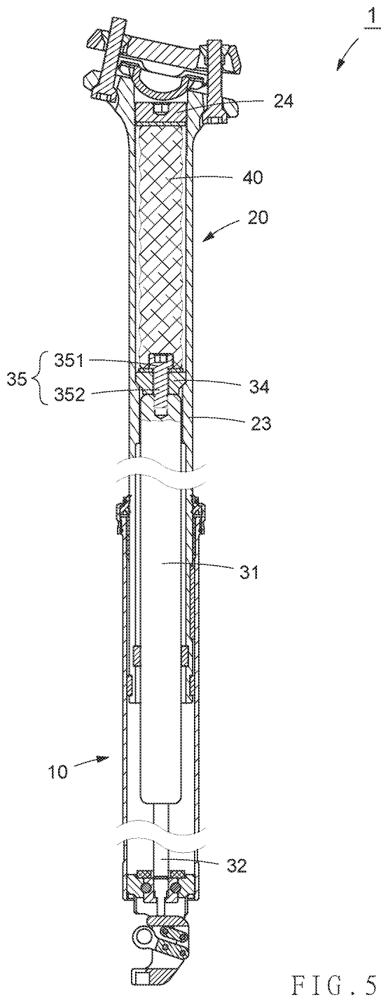

Based on the structural design of the height-adjustable seatpost 1, when a rider retracts the valve stem 32 of the height adjustment mechanism 30 to the shortest length, the inner tube 20 is placed at the lowest position. After the rider sits on the saddle, the rider's weight applies a force to the cap 24 of the inner tube 20, which in turn pushes against the shock absorber 40. At this time, because the height adjustment mechanism 30 and the stopper 34 are stand still, the shock absorber 40 is compressed and accumulates elasticity, resulting in that the inner tube 20 moves a compressed distance downward, as shown in FIG. 4. The compressed distance depends on the rider's weight; the heavier the rider is, the greater the compressed distance is. Then, when the rider wants to adjust the height of the saddle and thus gets off the saddle, the force applied to the shock absorber 40 is released and thus the elastic rebounding force of the shock absorber 40 drives the inner tube 20 to move upward, the stop flange 23 of the inner tube 20 abuts against the stopper 34 of the height adjustment mechanism 30, as shown in FIG. 5. As a result, the position of the inner tube 20 relative to the outer tube 10 remains the same before the inner tube 20 is driven, no matter how great the compressed distance is. After that, when the valve stem 32 of the height adjustment mechanism 30 is driven to extend by the rider, the inner tube 20 can be driven to move upward to a desired or a predetermined height. That is to say, the difference between the rider's expected saddle's travel distance and the actual travel distance of the height-adjustable seatpost can be effectively reduced. Accordingly, the likelihood of the saddle being raised to an unexpected height can be effectively reduced.

While the present disclosure has been described with reference to the above embodiments, it should be understood that the embodiments are provided for illustrative purposes only and are not intended to limit the scope of the present disclosure. Any modifications or variations made by those skilled in the art within the spirit of the present disclosure shall fall within the scope of the present disclosure.

1. A height-adjustable seatpost with shock absorption, comprising:
an outer tube;
an inner tube vertically movably disposed in the outer tube and having a head located outside the outer tube and a bottom opposite the head and situated inside the outer tube, the inner tube further having a stop flange located on an inner wall of the inner tube;
a height adjustment mechanism located inside the inner tube and being configured to drive the inner tube to move relative to the outer tube, the height adjustment mechanism having a stopper located above the stop flange and being abuttable against the stop flange; and
a shock absorber having two ends respectively abutted against the head of the inner tube and the stopper.

2. The height-adjustable seatpost as claimed in claim 1, wherein the height adjustment mechanism is a pneumatic cylinder including a valve seat and a valve stem vertically movably disposed in the valve seat and connected to the outer tube.

3. The height-adjustable seatpost as claimed in claim 2, wherein the valve seat has a top provided with a screw hole, the stopper has a through hole, and the height adjustment mechanism includes a screw passing through the through hole and screwing into the screw hole.

4. The height-adjustable seatpost as claimed in claim 3, wherein the shock absorber is a shock-absorbing rubber.

5. The height-adjustable seatpost as claimed in claim 4, wherein the shock absorber has a bottom provided with a recess.

6. The height-adjustable seatpost as claimed in claim 5, wherein the screw has a screw head protruding from a top surface of the stopper and received in the recess and a screw rod integrally connected to the screw head.

7. The height-adjustable seatpost as claimed in claim 6, wherein the recess has an inner ring surface tightly connected to the screw head.

8. The height-adjustable seatpost as claimed in claim 2, wherein the stopper is integrally connected to the valve seat.

9. The height-adjustable seatpost as claimed in claim 1, wherein the head of the inner tube has an opening, and wherein the height adjustment mechanism is passed through the opening and connected to the outer tube.

10. The height-adjustable seatpost as claimed in claim 1, wherein the inner tube includes a cap and the head has a screw hole and an opening, wherein the screw hole is communicated with an exterior of the inner tube through the opening, wherein the height adjustment mechanism is passed through the opening and connected to the outer tube, wherein the cap is provided with an external thread around an outer edge of the cap, and wherein the cap is engaged with the screw hole of the head of the inner tube.

11. The height-adjustable seatpost as claimed in claim 10, wherein the cap has an end provided with a hexagonal hole.
